(19) United States
(12) Patent Application Publication
(10) Pub. No.: US 2017/0163703 A1
(43) Pub. Date: Jun. 8, 2017

(54) PLAYER-BASED PLAY METHOD AND DEVICE

(71) Applicants: LE HOLDINGS (BEIJING) CO., LTD., Beijing (CN); LE SHI ZHI XIN ELECTRONIC TECHNOLOGY (TIANJIN) LIMITED, Tianjin (CN)

(72) Inventors: Jianyong Cui, Tianjin (CN); Jijian Zheng, Tianjin (CN); Hong Cao, Tianjin (CN)

(21) Appl. No.: 15/245,938

(22) Filed: Aug. 24, 2016

Related U.S. Application Data
(63) Continuation of application No. PCT/CN2016/089258, filed on Jul. 7, 2016.

(30) Foreign Application Priority Data
Dec. 3, 2015 (CN) 201510885362.8

(51) Int. Cl. H04L 29/06; H04L 12/925

(52) U.S. Cl. CPC H04L 65/601; H04L 65/607; H04L 47/722

(57) ABSTRACT

An embodiment of the present disclosure discloses a player-based play method and a player device. The method comprises: monitoring a player and generating a seek event of the player during the process of playing streaming media; determining a target segment of the streaming media according to the seek event, and acquiring buffer data of the target segment; and playing streaming media from the buffer data of the target segment. Through skipping over to the buffer data of the target segment, the embodiment of the present disclosure directly plays streaming media starting from buffer data of the target segment, so the player does not need to seek the key frame when adjusting the play progress, avoiding the problem of time waste caused by seeking the key frame, improving the starting efficiency of the player, and saving time.

### CROSS-REFERENCE TO RELATED APPLICATIONS

This application is a continuation of International Application No. PCT/CN2016/089258 filed on Jul. 7, 2016, which is based upon and claims priority to Chinese Patent Application No. 201510885362.8, entitled “PLAYER-BASED PLAY METHOD AND DEVICE”, filed Dec. 3, 2015, the entire contents of all of which are incorporated herein by reference.

### TECHNICAL FIELD

The present disclosure generally relates to the streaming media technical field, in particular to a player-based play method and a player device.

### BACKGROUND

Along with the rapid development of network technologies, popularization of players becomes faster and faster, and functions of players become richer and richer. Wherein, seek function is a basic function of a player. Through the seek function, the play progress of the player may be adjusted, meaning that the play position of streaming media may be adjusted, for example, users may skip over uninteresting contents through fast-forward or fast-backward operations.

During the process of realizing the present disclosure, the inverter found that streaming media such as videos and audio are transferred through streaming-oriented technologies (namely streaming media technologies), namely transfer through a TS (Transfer Stream) data packet. Wherein, the TS data packet is usually called TS segment. In simple terms, a streaming media source data exist in form of TS segments. A plurality of TS segments constitutes a streaming media source data. During play, when a seek event is detected, the player needs to seek a key frame which is closest to a time point of a seek event. Specifically speaking, the player needs to seek a key frame closest to the time point in a TS segment in which the time point determined by the seek event determined belongs to. After finding the key frame, the player may adjust the play progress and change the play position of streaming media. The player needs to start from the first frame of the TS segment to seek the key frame closest to the time point determined by the seek event, and seeking the key frame is time-consuming, so the player cannot start to play quickly. Therefore, during the process of adjusting the play progress, the player has a problem of starting efficiency is low.

### SUMMARY

The technical problem to be solved in the embodiment of the present disclosure is to provide a player-based play method, avoiding the problem of low starting efficiency of the player caused by seeking the key frame, and improving the starting efficiency of the player.

Correspondingly, an embodiment of the present disclosure also provides a player device to ensure realization and application of the method.

To solve the problem, an embodiment of the present disclosure discloses a player-based play method, comprising:

during the process of playing streaming media, monitoring a player, and generating a seek event of the player;

determining a target segment of the streaming media according to the seek event, and acquiring buffer data of the target segment;

and playing streaming media from the buffer data of the target segment.

Correspondingly, an embodiment of the present disclosure discloses an electronic device, player device, comprising at least one processor; and a memory communicably connected with the at least one processor for storing instructions executable by the at least one processor, wherein execution of the instructions by the at least one processor causes the at least one processor to:

monitor a player and generate a seek event of the player during the process of playing streaming media;

determine a target segment of the streaming media according to the seek event, and acquire buffer data of the target segment;

play streaming media from the buffer data of the target segment.

An embodiment of the present disclosure discloses a non-transitory computer readable medium storing executable instructions that, when executed by an electronic device, cause the electronic device to:

monitor a player and generate a seek event of the player during the process of playing streaming media;

determine a target segment of the streaming media according to the seek event, and acquire buffer data of the target segment;

play streaming media from the buffer data of the target segment.

Compared with the prior art, the embodiment of the present disclosure includes the following advantages:

During the process of playing streaming media, the embodiment of the present disclosure generates a seek event of the player and determines a target segment according to the seek event by monitoring the player, plays streaming media starting from buffer data of the target segment through skipping to the buffer data of the target segment, so the player does not need to seek the key frame when adjusting the play progress, avoiding the problem of time waste caused by seeking the key frame, improving the starting efficiency of the player, and saving time.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a step flowchart of a player-based play method in accordance with some embodiments.

FIG. 2 is a step flowchart of a player-based play method in accordance with some embodiments.

FIG. 3A is a structural block diagram of a player device in accordance with some embodiments.

FIG. 3B is a structural block diagram of a player device in accordance with some embodiments.

FIG. 4 schematically illustrates a block diagram of an electronic device for executing the method in accordance with some embodiments.

FIG. 5 schematically illustrates a memory cell for holding or carrying program codes for realizing the method in accordance with some embodiments.

### DETAILED DESCRIPTION

To clarify the objectives, technical solutions and advantage of the embodiments of the present disclosure, the technical solutions in embodiments of the present disclosure are clearly and completely described below with reference to drawings in the embodiments of the present disclosure. Obviously, the described embodiments are some embodiments of the present disclosure, not all the embodiments of the present disclosure. Based on the embodiments in the present disclosure, a person skilled in the art may obtain other embodiments without creative labor, which shall all fall within the protection scope of the present disclosure.

To play a video, the player needs to acquire data of the video, for example a playlist, TS segments, etc. of the video. Wherein, the playlist organizes the sequence of the TS segments of the video. Taking network video play as an example, a player sends a data request to a server to request an address of a network video source, namely requesting source data. The server responds to the data request and feeds back data related to the network video to the player so that the player may play the network video. Usually, when the server is an HTTP (Hyper Text Transfer Protocol) server, the request process needs to comply with three links of HPPT handshake.

First handshake: The player of a client sends an SYN (synchronous) packet (syn=j) to the server, enters SYN_SEND status, and waits for the server to make an acknowledgment.

Second handshake: The server receives the SYN packet, needs to confirm SYN (ack=j+1) of the client, and sends an SYN packet (syn=k) itself at the same time, namely SYN+ACK (Acknowledgment) packet, and then the server enters SYN_RECV status.

Third handshake: The client receives the SYN+ACK packet of the server, and sends an acknowledgment packet ACK (ack=k+1) to the client, and after sending the acknowledgment packet is finished, the client and the server enter ESTABLISHED status, completing three times of handshake.

After handshake is completed, the player and server of the client may transfer data. Wherein, the transferred data are TS segments. The player plays data after receiving the data.

Actually, during play, users do not have very high requirements for play accuracy of the player after the play progress is adjusted. Compared with the requirements for play accuracy, users have higher requirements for starting efficiency. Therefore, after the play position is adjusted, the player needs to start to play quickly, meaning that it is needed to improve the starting efficiency of the player.

Aiming at the above problems, a core concept of the embodiment of the present disclosure lies in that, the player determines the target segment through the seek event, plays streaming media from the buffer data of the target segment, namely skipping over to the target segment and directly playing from the buffer data of the target segment, without seeking the key frame closest to the time point determined by the seek event, thereby avoiding the problem of time waste caused by seeking the key frame, and improving the starting efficiency of the player.

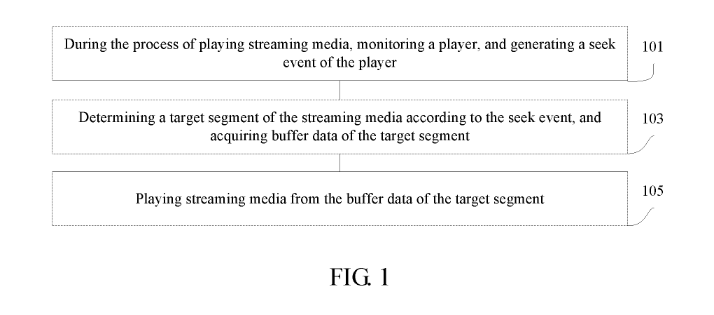

Refer to FIG. 1, which illustrates a step flowchart of a player-based play method according to an embodiment of the present disclosure. The method may specifically include the following steps.

Step 101: During the process of playing streaming media, monitoring a player, and generating a seek event of the player.

Streaming media, namely streaming-oriented media, may specifically refer to continuous time-based media employing the streaming transfer technology in the Internet or Intranet, such as audio, video, multimedia files, etc. Usually, streaming media may be played by using a player, for example, playing videos with a video player, playing music with an audio player, playing network videos with a webpage player, etc. The embodiment of the present disclosure does not set a limit in this aspect. For convenient description, videos are taken as an example below to describe the embodiment of the present disclosure in details, which should not be regarded as the limit in the embodiment of the present disclosure.

As a specific example of the embodiment of the present disclosure, when a player plays a video, a system, for example the Android system, may detect a user's operation command on the player, and then may monitor the player which is in operation. Usually, if a user hopes that the player skips over uninteresting video contents, the user may perform a fast-forward operation and/or a fast-backward operation to adjust the play position of the player, for example, when the user drags a play progress bar forward to a designated play position, the player responds to the fast-forward operation of the user and generates a fast-forward operation command. When the fast-forward operation command or fast-backward operation command is monitored, through a player event captured by analysis, a play time point corresponding to the player event may be determined, and the determined play time point is used as the starting time point after adjustment to the play progress to generate a seek event of the player, for example generating a function seek ( ).

Step 103: determining a target segment of the streaming media according to the seek event, and acquiring buffer data of the target segment.

The player may seek a playlist corresponding to the currently played video according to the seek event, determine a TS segment corresponding to the seek event, and define the TS segment corresponding to the seek event as the target segment of the video. The video which is being played includes a plurality of TS segments (for example 20 pieces) which may be respectively marked as segment 1, segment 2, segment 3, . . . in the playlist, and the rest may be done in the same way; and the play sequence and play time of the segments are marked, for example, the play time length of the video is 30 min, wherein the play time of the segment 1 of the video is 1-10 s; the play time of the segment 2 is 11-22; the play time of the segment 2 . . . , and the rest may be done in the same way until all TS segments are marked, meaning that the playlist is a complete video playlist. The play time of the segment 1 is 1-10 s, and the play time of the segment 2 is 11-22 s. This represents that, the segment 1 is played within 10 s before the play starts, the play of the segment 1 completed at the moment of 10 s; then, the segment 2 is played, meaning that the play of the segment 2 starts from the 11th second. For example, a seek event seekto (00:10:30) is monitored, wherein “00:10:30” represents that the starting time of the seek event seekto ( ) is 30 s of the tenth minute, namely at the moment of 630 s. Providing that the play time of the segment 9 is 626-640 s, meaning that the ninth segment of the video is played from the moment of 626 s to the moment of 640 s. Then, it may be determined that, the segment that the starting time, the 630th second, determined by the seek event seekto (00:10:13) belongs is segment 9, meaning that, the TS segment corresponding to seek event seekto (00:10:13) is segment 9, and segment 9 is taken as the target segment. After the target segment is determined, the buffer data of the target segment may be obtained, and the play progress of the player is adjusted to continue to play the video.

Optionally, the process that the player acquires the buffer data of the target video may include: determining if the buffer area of the player contains the buffer data of the target segment; when the buffer does not contain the buffer data of the target segment, downloading the target segment, generating the buffer data of the target segment, storing the buffer data in the buffer area; and if the buffer area contains the buffer data of the target segment, acquiring the buffer data of the target segment from the buffer area.

Step 105: playing streaming media from the buffer data of the target segment.

The player may acquire the buffer data from the head of the target segment acquiring the target segment, and then play the video. Specifically, a TS segment includes a plurality of frames, and the first frame of the TS segment is a key frame. The player may skip over to a position corresponding to the first frame from the target segment, directly acquire the buffer data from the position corresponding to the first frame, and then play the video.

For example, the ninth segment is acquired as mentioned above, and then the player starts to play the video from the first frame of the segment 9, namely starting to play the video from the position of the 626th second. Actually, the play time length of the streaming media corresponding to every segment is usually short, so playing from the segment does not cause too much influence on the user, which means that, when adjusting the play progress, the player may directly skip over to the first frame of the target segment, and play the video from the first frame without seeking the key frame closest to the 630th second, meaning that it is not needed to seek the key frame closest to the time point determined by the seek event, avoiding the problem of time waste caused by seeking the key frame, and improving the starting efficiency.

During the process of playing streaming media, the embodiment of the present disclosure generates a seek event of the player and determines a target segment according to the seek event by monitoring the player, plays streaming media starting from buffer data of the target segment through skipping to the buffer data of the target segment, so the player does not need to seek the key frame when adjusting the play progress, avoiding the problem of time waste caused by seeking the key frame, improving the starting efficiency of the player, and saving time. Thus, the user experience is improved.

The embodiment of the present disclosure is continuously described with reference to an optimal embodiment of the present disclosure.

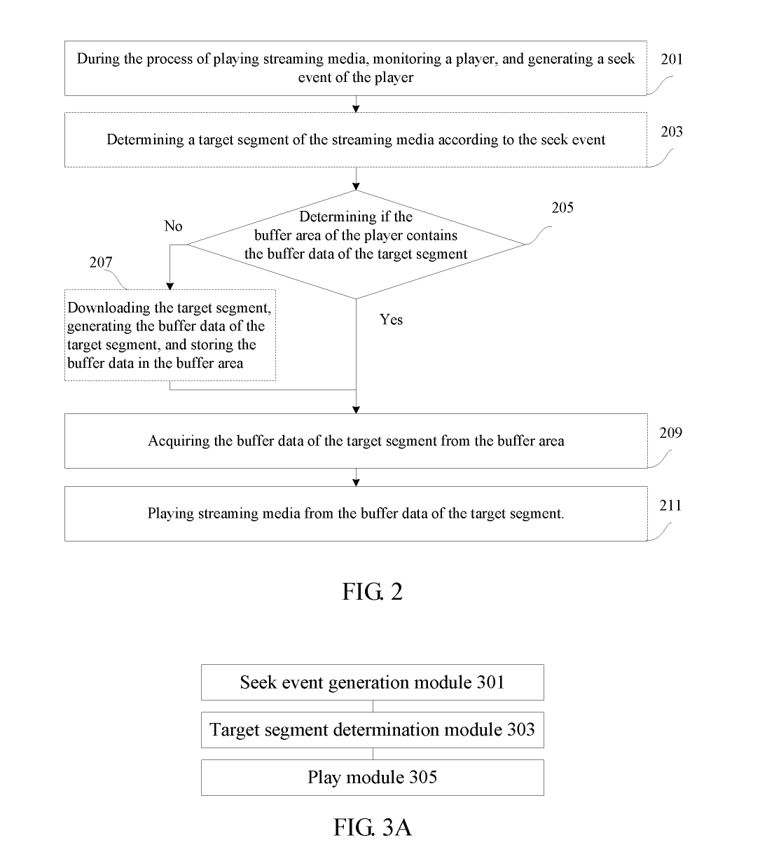

Refer to FIG. 2, which illustrates a step flowchart of a player-based play method according to an optimal embodiment of the present disclosure. The method may specifically include the following steps.

Step 201: During the process of playing streaming media, monitoring a player, and generating a seek event of the player.

Actually, during the process that the player plays the video, the user drags a cursor on the progress bar of the player to change the play position of the player. Of course, the user may also adjust the play progress of the player through controls such as a fast-forward control, a fast-backward control, etc. For example, through the fast-backward control, the player fast moves backward to the play position of the video contents which the user is interested in.

In an optimal embodiment of the present disclosure, the step of monitoring the player and generating the seek event of the player may include: capturing and analyzing a cursor sliding event of the player when a fast-forward or fast-backward operation command is monitored, determining the play time point pointed by the cursor which stays on the play progress bar after sliding; or capturing and analyzing a control triggering event of the player, determining the play time point corresponding to the control triggering event; defining the play time point as a starting point, and generating the seek event.

Specifically, the user may change the play position of the player through operations on the player, for example the fast-forward operation and the fast-backward operation. The system responds to the user's operation and automatically generates an operation command, for example, generating a fast-forward operation command in response to the fast-forward operation, and a fast-backward operation command in response to the fast-backward operation.

When the fast-forward or fast-backward operation command is monitored, it may be determined that if the progress bar is dragged through the user's operation, for example the operation of dragging the cursor on the progress bar of the player. If so, the cursor sliding event of the player is captured, and the cursor sliding event is analyzed to obtain the position information of the cursor which stays on the progress bar after sliding. Based on the position information and the length of the progress bar, the play time point pointed by the cursor, which stays on the play progress bar after sliding, may be determined. Wherein, the cursor sliding event may be generated according to a user's operation of dragging the progress bar. For example, providing that the progress bar of the player is 10 (cm) and it needs 30 min to finish the currently played video, the user drags the cursor to a position 1 away from the starting position of the progress bar, meaning that the position information acquired by the system is 1 (cm), and then the cursor sliding event is generated. Through calculation, it may be determined that, the play time point pointed by the cursor which stays on the progress bar after sliding is the 180th second, so the play time point, namely the 180th second, may be defined as the starting time point after adjustment of the play progress to generate the seek event seekto (00:03:00).

Of course, when the fast-forward or fast-backward operation command is monitored, if the user's operation triggers the operation of the player control, for example, clicking the fast-forward play control, may be determined. If so, a control triggering event of the player is captured; the captured control trigging event is analyzed; the play time point corresponding to the control triggering event is determined; the play time point is defined as the starting time point after adjustment of the play progress; and then seek event is generated. Wherein, the control triggering event of the player is automatically generated according the user's operation on the control.

Step 203: determining a target segment of the streaming media according to the seek event.

In an optimal embodiment of the present disclosure, the step 203 may also include the sub-steps as follows.

Sub-step 2031: seeking the playlist corresponding to the streaming media, and determining the segment corresponding to the starting time point in the seek event.

During specific realization, the player may determine the TS segment corresponding to the seek event through seeking the playlist corresponding to the currently played video according to the seek event. The TS segment that the starting time point belongs is equivalent to the segment corresponding to the starting time point in the seek event.

Sub-step 2032: defining the segment as the target segment.

After the TS segment corresponding to the starting time point is determined, the TS segment corresponding to the starting time point may be defined as the target segment to adjust the play position of the player. The specific adjustment is described later in the text.

Step 205: determining if the buffer area of the player contains the buffer data of the target segment.

Usually, the player acquires the buffer data of the TS segment from the buffer area and then plays the video. When the buffer area of the player does not contain the buffer data of the target segment, it is needed to download the target segment, and generate the buffer data of the target segment, namely executing step 207. When the player already contains the buffer data of the target segment, the buffer data of the target segment may be directly acquired from the buffer area, namely skipping over to step 209 to directly execute step 209.

Step 207: downloading the target segment, generating the buffer data of the target segment, and storing the buffer data in the buffer area.

When the buffer area does not contain the buffer data of the target segment, the player may generate a network request for downloading the target segment according to the playlist and send the network request to the server. After the server responds to the network request, the player may acquire the target segment from the server, namely downloading the target segment.

In an optimal embodiment of the present disclosure, downloading the target segment may include the following sub-steps.

Sub-step 2071: determining offset information corresponding to the target segment on the basis of the play list.

Actually, the playlist of the video may store the offset information of the TS segment in video format, for example ranging information range. Through seeking the playlist, the offset information corresponding to the target segment may be extracted from the playlist, such as offset address, offset time length, etc. Wherein, the offset address refers to a corresponding offset position of the TS segment of the video, relative to an initial address of the video; and the offset time length refers to corresponding offset time of an initial play time point of the TS segment of the video, relative to the initial play time point of the video.

Sub-step 2073: using the offset information to generate the network request.

Sub-step 2075: downloading the target segment from the server on the basis of the network request.

Specifically, the player uses the offset information to generate the network request, meaning that the generated network request contains the offset information corresponding to the target segment. The target segment may be found from the server according to the offset information included in the network request, and then the target segment is acquired. For example, the player uses the offset position of the target segment to generate a network request, such as a seek request. The offset position included in the seek request may ensure that the request reaches the target position when data are requested, meaning that, the position corresponding to the target segment may be found through the offset position included in the seek request, and the TS segment corresponding to the video may be acquired from the position of the target segment. In this way, the player may download the TS segment of the video, namely downloading the target segment from the server.

After the target segment is downloaded, an analyzer is used to analyze the target segment, and then the buffer data of the target segment may be generated. The player may cache the buffer data, namely storing the generated buffer data in the buffer area.

Step 209: acquiring the buffer data of the target segment from the buffer area.

When the buffer area contains the buffer data of the target area, the player may extract the buffer data of the target segment from the buffer area and then execute video play.

Step 211: playing streaming media from the buffer data of the target segment.

Optionally, the step 211 may also include the sub-steps as follows.

Sub-step 211: seeking the buffer area of the player, and determining the position corresponding to the first frame of the target segment.

Specifically speaking, the buffer area of the player is sought; when the buffer data of the target segment are found, meaning that when the buffer data corresponding to the first frame of the target segment are found, the position of the first frame of the target segment may be determined in the buffer area, meaning that the position corresponding to the first frame of the target segment may be determined.

Sub-step 2113: skipping over the position corresponding to the first frame, acquiring the buffer data from this position, and playing streaming media.

After the position corresponding to the first frame of the target segment is found, the player skips over to the position corresponding to the first frame, directly acquires the buffer data of the buffer area from this position, and plays the video. In this way, the player may adjust the play position and skip over the video contents that the current user is not interested in, improving the user experience.

In the embodiment of the present disclosure, the player skips over to the position corresponding to the first frame of the target segment, directly acquires the buffer data from the position corresponding to the first frame, and then plays the video, thus avoiding the problem of long starting time of the player caused by seeking the key frame closest to the time point determined by the seek event, improving the starting efficiency of the player, saving time and improving the user experience.

It is needed to be noted that, for simple description, the method embodiments are described as a series of action combinations, but a person skilled in the art understands that the embodiments of the present disclosure are not limited by the sequence of the described actions because according to the embodiments of the present disclosure, some steps may be implemented in other sequence or at the same time. Moreover, a person skilled in the art also should understand that the embodiments described in the present disclosure all belong to optimal embodiments, and some actions involved are not always needed by the embodiments of the present disclosure.

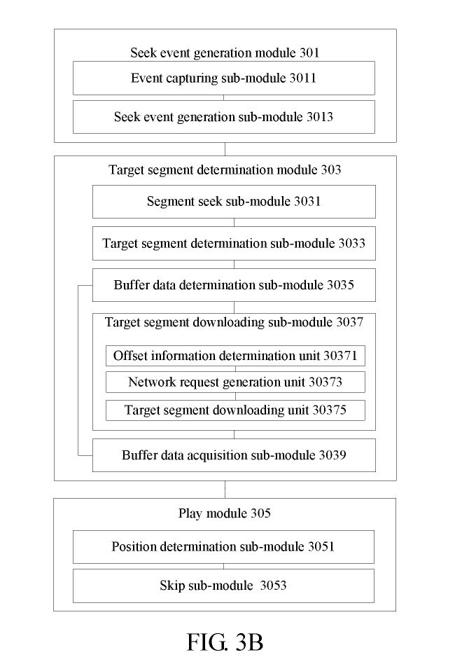

Refer to FIG. 3A, which illustrates a structural block diagram of a player device according to an embodiment of the present disclosure. The device may specifically include the following modules:

a seek event generation module 301, used for monitoring a player and generating a seek event of the player during the process of playing streaming media;

a target segment determination module 303, used for determining a target segment of the streaming media according to the seek event, and acquiring buffer data of the target segment;

a play module 305, used for playing streaming media from the buffer data of the target segment.

On the basis of the FIG. 3A, optionally, the seek event generation module 301 may include an event capturing sub-module 3011 and a seek event generation sub-module 3013. Refer to FIG. 3B.

The event capturing sub-module 3011 may be used for capturing and analyzing a cursor sliding event of the player when a fast-forward or fast-backward operation command is monitored, determining the play time point pointed by the cursor which stays on the play progress bar after sliding; or capturing and analyzing a control triggering event of the player, and determining the play time point corresponding to the control triggering event.

The seek event generation sub-module 3013 may be used for defining the play time point as the starting time point and generating the seek event.

Optionally, the target segment determination module 303 may include a segment seek sub-module 3031 and a target segment determination sub-module 3033. Wherein, the segment seek sub-module 3031 may be used for seeking the playlist corresponding to the streaming media, and determining the segment corresponding to the starting time point in the seek event. The target segment determination sub-module 3033 may be used for defining the segment as the target segment.

In an optimal embodiment of the present disclosure, the target segment determination module 303 may also include the following sub-modules:

a buffer data determination module 3035, used for determining if the buffer area of the player contains the buffer data of the target segment;

a target segment downloading sub-module 3037, used for downloading the target segment, generating the buffer data of the target segment, and storing the buffer data in the buffer area, when the buffer area does not contain the buffer data of the target segment.

Optionally, the target segment downloading sub-module 3037 may also include:

an offset information determination unit 30371, a network request generation unit 30373 and a target segment downloading unit 30375.

wherein, the offset information determination unit 30371 is used for determining offset information corresponding to the target segment on the basis of the play list; the network request generation unit 30373 is used for using the offset information to generate the network request; and the target segment downloading unit 30375 is used for downloading the target segment from the server on the basis of the network request;

and a buffer data acquisition sub-module 3039, used for acquiring the buffer data of the target segment from the buffer area when the buffer area contains the buffer data of the target segment.

In an optimal embodiment of the present disclosure, the play module 305 may include the following sub-modules:

a position determination sub-module 3051, used for seeking the buffer area of the player, and determining the position corresponding to the first frame of the target segment;

and a skip sub-module 3053, used for skipping over the position corresponding to the first frame, acquiring the buffer data from this position, and playing streaming media.

During the process of playing streaming media, the embodiment of the present disclosure generates a seek event of the player and determines a target segment according to the seek event by monitoring the player, plays streaming media starting from buffer data of the target segment through skipping to the buffer data of the target segment, so the player does not need to seek the key frame when adjusting the play progress, avoiding the problem of time waste caused by seeking the key frame, improving the starting efficiency of the player, and saving time. Thus, the user experience is improved.

The device embodiment is basically the same as the method embodiments and therefore is simply described. Related contents may be seen in the related description of the method embodiments.

All embodiments of the present disclosures are described in a progressive manner. Every embodiment focuses on different factors. Identical and similar parts of the embodiments may be reference of one another.

A person skilled in the art should understand that the embodiments of the present disclosure may be provided methods, devices or computer program products. Therefore, the embodiments of the present disclosure may be complete hardware embodiments, complete software embodiments or embodiments in combination of software and hardware. Besides, the embodiments of the present disclosure may be one or more computer program products implemented in computer accessible storage media (including but not limited to magnetic disc memories, CD-ROM, optical memories, etc.) which contain accessible program codes for computers.

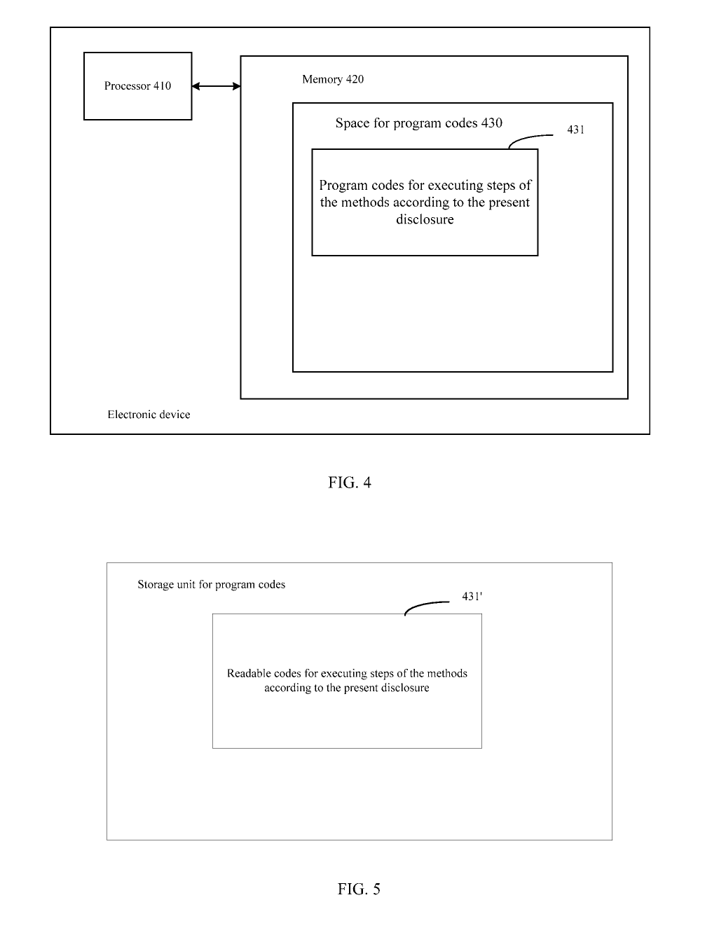

For example, FIG. 4 illustrates a block diagram of an electronic device for executing the method according the disclosure. Traditionally, the electronic device includes a processor 410 and a computer program product or a computer readable medium in form of a memory 420. The memory 420 could be electronic memories such as flash memory, EEPROM (Electrically Erasable Programmable Read-Only Memory), EPROM, hard disk or ROM. The memory 420 has a memory space 430 for executing program codes 431 of any steps in the above methods. For example, the memory space 430 for program codes may include respective program codes 431 for implementing the respective steps in the method as mentioned above. These program codes may be read from and/or be written into one or more computer program products. These computer program products include program code carriers such as hard disk, compact disk (CD), memory card or floppy disk. These computer program products are usually the portable or stable memory cells as shown in reference FIG. 5. The memory cells may be provided with memory sections, memory spaces, etc., similar to the memory 420 of the server as shown in FIG. 4. The program codes may be compressed for example in an appropriate form. Usually, the memory cell includes computer readable codes 431′ which may be read for example by processors 410. When these codes are operated on the server, the server may execute respective steps in the method as described above.

The embodiments of the present disclosure are described with reference to the flowcharts and/or block diagrams of the methods and terminal devices (system) and computer program products of the embodiments of the present disclosure. It should be understood that the computer program commands realize every process and/or block in the flowcharts and/or block diagrams, and the combination of processes and/or blocks in the flowcharts and/or block diagrams. The computer program command may be supplied to the processor of a universal computer, a special computer, an embedded processing machine or other programmable data processing terminals to generate a machine, so the commands executed by the processor of the computer or other programmable data processing terminals generate a device for realizing specific functions in one or more processes in the flowcharts and/or one or more blocks in the block diagrams.

The computer program commands may also be stored in computer readable memories which guide the computer or other data processing terminal devices to work in a specific mode, so the commands stored in the computer readable memories generate products including command devices, and the command devices conduct specific functions in one or more steps in the flowcharts and/or one or more blocks in the block diagrams.

The computer program commands may also be loaded in the computer or other programmable data processing terminal devices such that computer or other programmable processing terminal devices execute a series of operations to generate processing executed by the computer. Thus, the commands executed in the computer or other programmable terminal devices supply processes of conducting specific functions in one or more processes in the flowcharts and/or one or more blocks in the block diagrams.

Although the optimal embodiments of the present disclosure are described, a person skilled in the art may make other changes and modifications on those embodiments when understanding the basic creative concept. Therefore, the protection scope of the claims includes the optimal embodiments and all changes and modifications within the embodiments of the present disclosure.

Finally, it is needed to be noted that, in the text, the relationship terms such as the “first” and the “second” are used for merely distinguishing an entity or operation from another entity or operation, and it is not always required or hinted that those entities or operation have such practical relationships or are in such sequences. Besides, the terms “comprise”, “include” or any other synonyms are intended to cover non-exclusive inclusion, so the processes, methods, articles or terminal devices of a series of elements include not only those elements, but also other elements, which are not clearly listed, or also include all inherent factors of those processes, methods, articles or terminals device. In the case of no more limit, the elements defined by the sentence “comprising/including a/an . . . ” should not exclude that the processes, methods, articles or terminal devices including the elements also include other identical elements.

The above are detailed description of the player-based play method the player device. Specific examples are used in the text to describe the principle and implementation mode of the present disclosure. The description of the above embodiments is only used for clarifying the method and essential concepts of the present disclosure. Meanwhile, for a person skilled in the art, changes may be made to the specific implementation modes and application scope according to the concept of the present disclosure. In conclusion, the contents of the Description cannot be regarded as limit in the present disclosure.

What is claimed is:

1. A player-based play method, comprising:
at an electronic device:
during the process of playing streaming media, monitoring a player, and generating a seek event of the player;
determining a target segment of the streaming media according to the seek event, and acquiring buffer data of the target segment;
and playing streaming media from the buffer data of the target segment.

2. The method according to claim 1, wherein, the step of monitoring a player and generating a seek event of the player comprises:
capturing and analyzing a cursor sliding event of the player when a fast-forward or fast-backward operation command is monitored, determining the play time point pointed by the cursor which stays on the play progress bar after sliding; or capturing and analyzing a control triggering event of the player, and determining the play time point corresponding to the control triggering event;
and defining the play time point as the starting time point and generating the seek event.

3. The method according to claim 1, wherein, the step of determining the target segment of the streaming media according to the seek event comprises:
seeking a playlist corresponding to the streaming media, and determining the segment corresponding to a starting time point in the seek event;
and defining the segment as the target segment.

4. The method according to claim 1, wherein, the step of acquiring the buffer data of the target segment comprises:
determining if the buffer area of the player contains the buffer data of the target segment;
downloading the target segment, generating the buffer data of the target segment, and storing the buffer data in the buffer area, when the buffer area does not contain the buffer data of the target segment;
and acquiring the buffer data of the target segment from the buffer area when the buffer area contains the buffer data of the target segment.

5. The method according to claim 4, wherein, the step of downloading the target segment comprises:
determining offset information corresponding to the target segment on the basis of the play list;
using the offset information to generate the network request;
and downloading the target segment from the server on the basis of the network request.

6. The method according to claim 1, wherein, the step of playing streaming media from the buffer data of the target segment comprises:
seeking the buffer area of the player, and determining the position corresponding to the first frame of the target segment;
skipping over the position corresponding to the first frame, acquiring the buffer data from this position, and playing streaming media.

7. An electronic device, comprising:
at least one processor; and
a memory communicably connected with the at least one processor for storing instructions executable by the at least one processor, wherein execution of the instructions by the at least one processor causes the at least one processor to:
monitor a player and generate a seek event of the player during the process of playing streaming media;
determine a target segment of the streaming media according to the seek event, and acquire buffer data of the target segment;
play streaming media from the buffer data of the target segment.

8. The electronic device according to claim 7, wherein, monitor a player and generate a seek event of the player during the process of playing streaming media comprises:
capture and analyze a cursor sliding event of the player when a fast-forward or fast-backward operation command is monitored, determine the play time point pointed by the cursor which stays on the play progress bar after sliding; or capture and analyze a control triggering event of the player, and determine the play time point corresponding to the control triggering event;
define the play time point as the starting time point and generating the seek event.

9. The electronic device according to claim 7, wherein, determine a target segment of the streaming media according to the seek event, and acquire buffer data of the target segment comprises:
seek the playlist corresponding to the streaming media, and determine the segment corresponding to the starting time point in the seek event;
define the segment as the target segment.

10. The electronic device according to claim 7, wherein, determine a target segment of the streaming media according to the seek event, and acquire buffer data of the target segment comprises:
determine if the buffer area of the player contains the buffer data of the target segment;
download the target segment, generate the buffer data of the target segment, and store the buffer data in the buffer area, when the buffer area does not contain the buffer data of the target segment;
acquire the buffer data of the target segment from the buffer area when the buffer area contains the buffer data of the target segment.

11. The electronic device according to claim 10, wherein, download the target segment, generate the buffer data of the target segment, and store the buffer data in the buffer area, when the buffer area does not contain the buffer data of the target segment comprises:
determine offset information corresponding to the target segment on the basis of the play list;
use the offset information to generate the network request;
download the target segment from the server on the basis of the network request.

12. The electronic device according to claim 7, wherein, play streaming media from the buffer data of the target segment comprises:
seek the buffer area of the player, and determine the position corresponding to the first frame of the target segment;
skip over the position corresponding to the first frame, acquire the buffer data from this position, and play streaming media.

13. A non-transitory computer readable medium storing executable instructions that, when executed by an electronic device, cause the electronic device to:
monitor a player and generate a seek event of the player during the process of playing streaming media;
determine a target segment of the streaming media according to the seek event, and acquire buffer data of the target segment;
play streaming media from the buffer data of the target segment.

14. The non-transitory computer readable medium according to claim 13, wherein, monitor a player and generate a seek event of the player during the process of playing streaming media comprises:
capture and analyze a cursor sliding event of the player when a fast-forward or fast-backward operation command is monitored, determine the play time point pointed by the cursor which stays on the play progress bar after sliding; or capture and analyze a control triggering event of the player, and determine the play time point corresponding to the control triggering event;
define the play time point as the starting time point and generating the seek event.

15. The non-transitory computer readable medium according to claim 13, wherein, determine a target segment of the streaming media according to the seek event, and acquire buffer data of the target segment comprises:
seek the playlist corresponding to the streaming media, and determine the segment corresponding to the starting time point in the seek event;
define the segment as the target segment.

16. The non-transitory computer readable medium according to claim 13, wherein, determine a target segment of the streaming media according to the seek event, and acquire buffer data of the target segment comprises:
determine if the buffer area of the player contains the buffer data of the target segment;
download the target segment, generate the buffer data of the target segment, and store the buffer data in the buffer area, when the buffer area does not contain the buffer data of the target segment;
acquire the buffer data of the target segment from the buffer area when the buffer area contains the buffer data of the target segment.

17. The non-transitory computer readable medium according to claim 16, wherein, download the target segment, generate the buffer data of the target segment, and store the buffer data in the buffer area, when the buffer area does not contain the buffer data of the target segment comprises:
determine offset information corresponding to the target segment on the basis of the play list;
use the offset information to generate the network request;
download the target segment from the server on the basis of the network request.

18. The non-transitory computer readable medium according to claim 13, wherein, play streaming media from the buffer data of the target segment comprises:
seek the buffer area of the player, and determine the position corresponding to the first frame of the target segment;
skip over the position corresponding to the first frame, acquire the buffer data from this position, and play streaming media.
